(19) United States
(12) Patent Application Publication
(10) Pub. No.: US 2024/0253577 A1
(43) Pub. Date: Aug. 1, 2024

(54) QUASI-STEREO SINGLE WOOFER SYSTEM

(71) Applicant: Panasonic Automotive Systems Company of America, Division of Panasonic Corporation of North America, Peachtree City, GA (US)

(72) Inventors: Mark ZIEMBA, Livonia, MI (US); Anthony THOMPSON, White Lake, MI (US)

(21) Appl. No.: 18/423,399

(22) Filed: Jan. 26, 2024

Related U.S. Application Data
(60) Provisional application No. 63/442,377, filed on Jan. 31, 2023.

(51) Int. Cl. B60R 11/02; H04R 1/28

(52) U.S. Cl. CPC B60R 11/0217; H04R 1/2857; H04R 2499/13

(57) ABSTRACT

A compact audio woofer arrangement for a motor vehicle includes an enclosure installed in the motor vehicle. The enclosure contains a woofer or subwoofer emitting a sound. The enclosure includes a primary and secondary through-hole. The primary through-hole allows the woofer to interface with the interior of the vehicle and provides sound directly from the enclosure into a passenger compartment at the primary location. A extended vent acting as an acoustic transmission line is coupled to the second through-hole. The vent transmits sound from the enclosure to a secondary location remote from the primary location, such that the sound is emitted into the adjacent passenger compartment. The primary and secondary acoustic outputs differ by physical location in the motor vehicle, and also by frequency response of the emitted sound, thereby emulating a quasi-stereo environment.

### CROSS-REFERENCED TO RELATED APPLICATIONS

This application claims benefit of U.S. Provisional Application No. 63/442,377, filed on Jan. 31, 2023, the disclosure of which is hereby incorporated by reference in its entirety for all purposes.

### BACKGROUND OF THE INVENTION

### 1. Field of the Invention

The present invention relates to automotive audio systems.

### 2. Description of the Related Art

Compact audio is a new audio system format that has arisen in the electric vehicle (EV) market. A compact audio system employs less than four speakers with an emphasis on weight, size, and reduced complexity. A typical application may use two high frequency drivers coupled with a single larger loudspeaker to augment lower frequencies.

The most significant problem of low frequency distribution in a compact audio system is that a solo speaker tends to project bass from a single location. This breaks the basic tenets of stereo sound delivery, with there being no difference in perceived location and content between the left and right input channels coming out of the loudspeaker.

The primary problem in compact audio is one of adequate bass delivery in a localized, compact format that also allows for efficiency. As such, there aren't many examples to compare against. Prototypical systems that have been revealed at trade shows and conferences are typically one-piece solutions that house a single dash- or console-based woofer, coupled with additional high frequency drivers. Such systems will inevitably have problems with full bandwidth stereo when employed in a production vehicle.

### SUMMARY OF THE INVENTION

The invention addresses the above-described problem of a compact audio system by creating two discrete locations in the vehicle where bass is delivered, thereby creating a quasi-stereo environment.

The invention may provide a critical, singular component of a compact audio system. The invention may provide a unique application of low frequency audio delivery.

In its primary embodiment, the invention provides a vented woofer that uses an extended, exterior port to transmit acoustic energy to a specific, predetermined point in the vehicle. The woofer is housed in a hollow enclosure and mounted on one side of the vehicle cabin. An elongated vent acting as an acoustic transmission line is attached to the same enclosure and extends to the opposite side of the cabin. In essence, two discrete acoustic transmission points are created in the vehicle, each of which produce a different frequency response distribution. The spectral difference between the two acoustic points augments the quasi-stereo perception.

The invention may provide any combination of a mounted loudspeaker on one end (acoustic termination #1) and an extended port on the other (acoustic termination #2), as applied within a motor vehicle distributing sound across adjacent passenger compartments.

The invention comprises, in one form thereof, a compact audio woofer arrangement for a motor vehicle, including an enclosure installed in the motor vehicle. The enclosure contains a woofer or subwoofer emitting sound. The enclosure includes both a primary and secondary through-hole. The primary through-hole allows the woofer to interface with the interior of the vehicle and provides sound directly from the enclosure into a passenger compartment at the primary location. An extended vent is coupled to the secondary through-hole. The vent transmits sound from the enclosure to a secondary location remote from the primary location, such that the sound is emitted into the adjacent passenger compartment. The sound emitted from both locations represent different but complementary frequency responses.

The invention comprises, in yet another form thereof, a configuration identical to the aforementioned solution, although with the addition of a digital signal processing (DSP)-based sound mixing implementation that supplies the woofer with a unique equalization applied to each channel. By emphasizing certain frequency ranges of one input channel and de-emphasizing the same frequency ranges in the other input channel, we are able to enhance the stereo effect (the difference of the level of one input channel compared to the other) out of each Source #1 and Source #2.

The direct output of the woofer is Source #1. The typical acoustic frequency response of Source #1 is shown by FIG. 2. The typical response of the output of the long transmission line or port is shown by FIG. 3. As it can be clearly seen, the acoustic response of each of these sources differs significantly, creating a quasi-stereo effect between the two sources, and thus a perceptible difference between the left and the right channel acoustic outputs from a single woofer system.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of a passenger compartment of a motor vehicle including one embodiment of a compact audio woofer arrangement of the present invention.

FIG. 2 is a plot of the typical acoustic response of the direct sound from the woofer (Source #1).

FIG. 3 is a plot of the typical acoustic frequency response from the extended transmission line or port (Source #2).

FIG. 4 is a flow chart of one embodiment of a method of the present invention for providing sound in a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

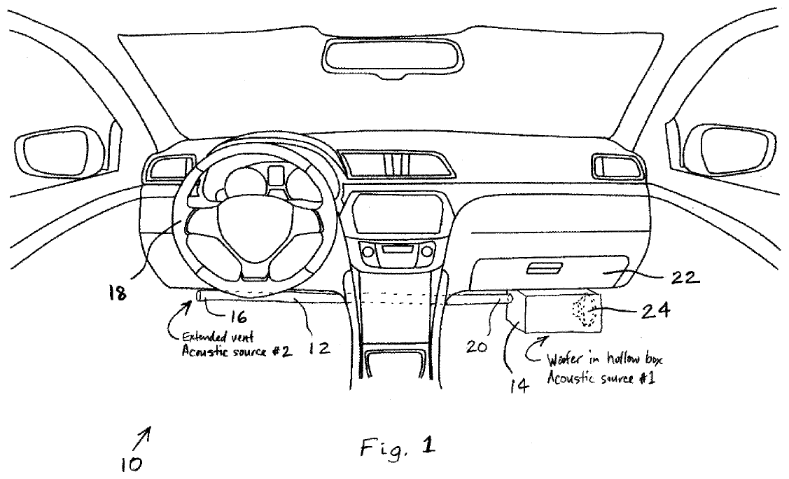

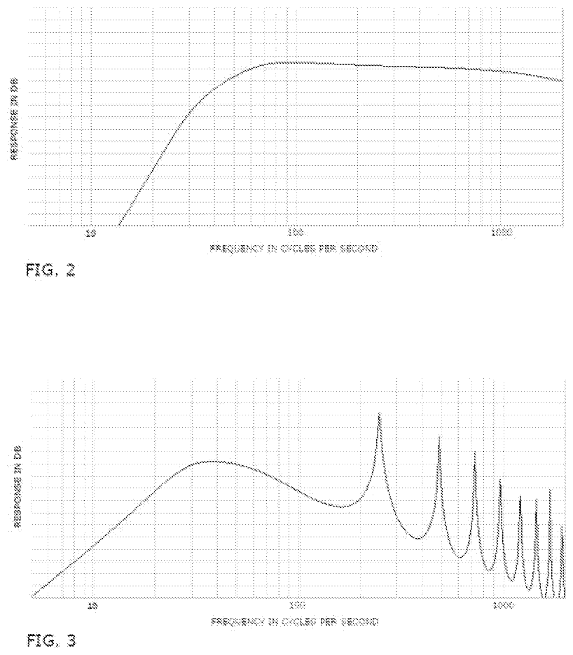

FIG. 1 illustrates one embodiment of a compact audio woofer arrangement 10 of the present invention, including a vent 12 extending out of a hollow enclosure 14 that is on a passenger side of the motor vehicle. In one embodiment, the height, width and length of enclosure 14 are all less than twelve inches. Vent 12 is a hollow conduit including an open left end 16 into the foot well below steering wheel 18 on a driver side of the motor vehicle, and a right end 20 extending into hollow enclosure 14 below glove enclosure 22. Open end 16 may be disposed remote from enclosure 14. For example, open end 16 may be disposed approximately between one foot and five feet from enclosure 14.

Enclosure 14 contains a woofer 24 that may emit sound through a through-hole (not shown) in enclosure 14. Woofer 24 also emits sound into an interior of enclosure 14, and this emitted sound is carried by vent 12 to the open end of vent 12 at its left end 16. Thus, the sound is emitted by vent 12 into the foot well below steering wheel 18, while the sound is also emitted by enclosure 14 into the space below glove enclosure 22.

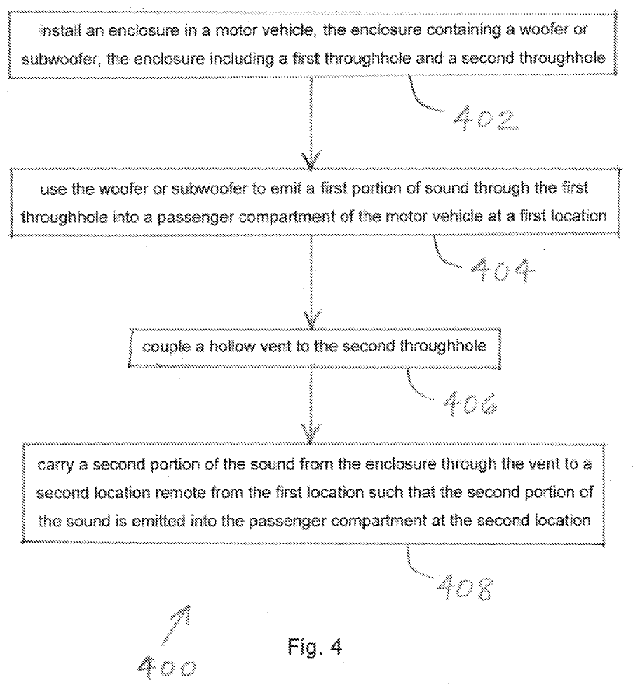

FIG. 4 illustrates one embodiment of a method 400 of the present invention for providing sound in a motor vehicle. In a first step 402, an enclosure is installed in the motor vehicle. The enclosure contains a woofer or subwoofer. The enclosure includes a first throughhole and a second throughhole. For example, enclosure 14 is installed in a passenger side of a motor vehicle and contains a woofer 24. Enclosure 14 includes a first through-hole through which woofer 24 may emit sound, and a second through-hole in communication with vent 12.

Next, in step 404, the woofer or subwoofer is used to emit a first portion of sound through the first throughhole into a passenger compartment of the motor vehicle at a first location. For example, woofer 24 emits a first portion of sound through the first throughhole into a passenger compartment of the motor vehicle at a first location below glove enclosure 22.

In a next step 406, a hollow vent is coupled to the second throughhole. For example, hollow vent 12 is coupled to the second throughhole of enclosure 22.

In a final step 408, a second portion of the sound is carried from the enclosure through the vent to a second location remote from the first location such that the second portion of the sound is emitted into the passenger compartment at the second location. For example, a second portion of the sound is carried from enclosure 22 through vent 12 to a second location below steering wheel 18 that is remote from the first location. The second portion of the sound is emitted from left end 16 of vent 12 into the passenger compartment at the second location.

Although the invention has been shown in FIG. 1 as carrying sound horizontally between two front seats of a motor vehicle, it is to be understood that the invention may be applied to carry sound between any two locations within a passenger compartment of a motor vehicle. For example, the invention may be used to carry sound between back seats; between a front seat and a back seat; between two different vertical levels; or between any combination of the above.

Although the invention has been shown in the drawings as including a linear vent with an interior channel having a constant, circular cross section, it is to be understood that vents having other shapes and cross sections are within the scope of the invention. For example, the vent may have bends and/or arcuate sections that may be needed to get around other components in the motor vehicle. It is also possible for the interior channel of the vent to have a square, rectangular, triangular, or oval cross section. It is also possible for the interior channel of the vent to vary along its length in terms of shape and/or width or other dimension.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A compact audio woofer arrangement for a motor vehicle, the arrangement comprising:
an enclosure configured to be installed in the motor vehicle, the enclosure containing a woofer or subwoofer configured to emit a sound, the enclosure including a primary through-hole and a secondary through-hole, the primary through-hole being configured to release a first portion of the sound from the enclosure into a passenger compartment of the motor vehicle at a primary location; and
a hollow vent coupled to the secondary through-hole, the hollow vent being configured to carry a second portion of the sound from the enclosure to a second location remote from the first location such that the second portion of the sound is emitted into the passenger compartment at the second location.

2. The arrangement of claim 1 wherein the first location is at least 12 inches from the second location.

3. The arrangement of claim 1 wherein a height, width and length of the enclosure are all less than 12 inches.

4. The arrangement of claim 1 wherein the hollow vent is substantially linear.

5. The arrangement of claim 1 wherein the enclosure is on a passenger side of the motor vehicle and is disposed forward of a front seat of the motor vehicle.

6. The arrangement of claim 5 wherein the second location is on a driver side of the motor vehicle and is disposed forward of a front seat of the motor vehicle.

7. The arrangement of claim 6 wherein the enclosure is disposed below a glove box of the motor vehicle, and the second location is disposed below the dash and adjacent to a steering wheel of the motor vehicle.

8. A method for providing sound in a motor vehicle, the method comprising:
installing an enclosure in the motor vehicle, the enclosure containing a woofer or subwoofer, the enclosure including a first throughhole and a second throughhole;
using the woofer or subwoofer to emit a first portion of sound through the first throughhole into a passenger compartment of the motor vehicle at a first location;
coupling a hollow vent to the second throughhole; and
carrying a second portion of the sound from the enclosure through the vent to a second location remote from the first location such that the second portion of the sound is emitted into the passenger compartment at the second location.

9. The method of claim 8 wherein the first location is at least 30 inches from the second location.

10. The method of claim 8 wherein a height, width and length of the enclosure are all less than 12 inches.

11. The method of claim 8 wherein the hollow vent is substantially linear.

12. The method of claim 8 wherein the enclosure is on a passenger side of the motor vehicle and is disposed forward of a front seat of the motor vehicle.

13. The method of claim 12 wherein the second location is on a driver side of the motor vehicle and is disposed forward of a front seat of the motor vehicle.

14. The method of claim 13 wherein the enclosure is disposed below a glove box of the motor vehicle, and the second location is disposed below a steering wheel of the motor vehicle.

15. A compact audio woofer arrangement for a motor vehicle, the arrangement comprising:
an enclosure configured to be installed in the motor vehicle, the enclosure containing a woofer or subwoofer configured to emit a sound, the enclosure including a first throughhole and a second throughhole, the first throughhole being configured to pass a first portion of the sound from the enclosure into a passenger compartment of the motor vehicle at a first location; and
a hollow vent coupled to the second throughhole, the hollow vent being configured to carry a second portion of the sound from the enclosure to a second location such that the second portion of the sound is emitted into the passenger compartment at the second location, the second location being at least three feet from the first location.

16. The arrangement of claim 15 wherein a height, width and length of the enclosure are all less than 16 inches.

17. The arrangement of claim 15 wherein the hollow vent is substantially linear.

18. The arrangement of claim 15 wherein the enclosure is on a passenger side of the motor vehicle and is disposed forward of a front seat of the motor vehicle.

19. The arrangement of claim 18 wherein the second location is on a driver side of the motor vehicle and is disposed forward of a front seat of the motor vehicle.

20. The arrangement of claim 19 wherein the enclosure is disposed below a glove box of the motor vehicle, and the second location is disposed below a steering wheel of the motor vehicle.
